(19) United States
(12) Patent Application Publication
(10) Pub. No.: US 2006/0182048 A1
(43) Pub. Date: Aug. 17, 2006

(54) Wireless communication terminal with a call particulars output function of a scheduler interface and method therefor

(75) Inventors: Chang-Seok Cho, Seoul (KR); Jin-Gi Song, Seoul (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Pantech Co., Ltd.

(21) Appl. No.: 11/313,008

(22) Filed: Dec. 19, 2005

(30) Foreign Application Priority Data
Feb. 16, 2005 (KR) 10-2005-0012670

(51) Int. Cl. H04B 7/00

(52) U.S. Cl. 370/310

(57) ABSTRACT

A wireless communication terminal with a call particulars output function using a scheduler interface and method therefor are provided to learn a distribution of call particulars in months more easily and also do a schedule management more easily. The invention includes a wireless transceiver for transmitting and receiving a wireless signal to and from external equipments, a storage device for storing a call log including call particulars, and a scheduler interface providing program, an input device for receiving a call particulars output request signal, an output device for outputting information under the control of a controller, and the controller for controlling each of the elements to activate the scheduler interface providing program stored in the storage device in response to the call particulars output request signal, search call particulars for a selected month from the call log, and output the searched information via a scheduler interface.

### FIELD OF THE INVENTION

The present invention relates to a wireless communication terminal with a call particulars output function of a scheduler interface and method therefor; and more particularly, to a wireless communication terminal with a call particulars output function of a scheduler interface and method therefor which is capable of learning a distribution of call particulars (incoming/originating call particulars and absent telephone particulars) in months more easily and elevating a convenience of schedule management by displaying user's call particulars as the unit of month together with the user's schedule details through the use of a scheduler interface.

### DESCRIPTION OF RELATED ART

A wireless communication terminal refers to a terminal capable of wireless communication while a person carries such a terminal as personal communication services (PCS) terminal, personal digital assistant (PDA) terminal, smart phone, International Mobile Telecommunication-2000 (IMT-2000) terminal, wireless LAN terminal, or the like.

These days, the wireless communication terminal is equipped with a variety of supplementary functions as well as communication functions such as speech call and message transmission and reception and so on. In other words, such terminal provides various kinds of supplementary functions such as a scheduler for registering and managing a personal schedule for each date using a calendar indicated as the unit of month, a memo for storing information on promise or important matters, an alarm for notifying preset contents via bell sound or vibration, etc. at a specific time, and an image acquisition using cameral module that is built in or prepared on the outside.

With the supplementary functions provided by the terminal, the user can live a convenient life. The supplementary functions are that the user registers a personal schedule (e.g., promise) using a scheduler with the form of calendar or memo function and sets alarm to sound at a required time to manage the personal schedule, or acquires and then stores an acquaintance's picture using a camera module to be matched with his (her) name and phone number, and so on, to automatically display the counterpart picture when there is an issuance of call incoming/originating.

On the other hand, upon the call incoming/originating, the call particulars stored in the wireless communication terminal contains a phone number, an incoming/originating time, information on call success or failure (absent telephone in case of failure), a total call duration, etc., including a counterpart name if the counterpart information was stored in advance within the terminal. The call particulars may be classified into incoming items, originating items, absent telephone items, etc., according to the functions provided by the terminal, and then stored.

Since, however, the call particulars items according to the prior art are displayed in the form of text-centered list, there has existed a problem that a distribution in terms of periods with respect to an issuances of incoming/originating signal and absent telephone can't readily be learnt. Namely, the call particulars are not divisionally displayed as the unit of month/date but displayed in the form of list in a lump; and thus, this method needs to search and confirm each call particulars via a series of key inputs, respectively, to grasp a distribution of incoming/originating signals and absent telephones that occur during a certain period (e.g., one month).

Further, in case of the call particulars items according to the prior art, there exists a shortcoming that it is difficult for the user to clearly learn incoming/originating call particulars with a specific counterpart and absent telephone particulars at a glance. That is to say, the call particulars are not sorted and displayed depending on the call counterpart, and for example, the whole call particulars are displayed in the sequence of time; and therefore, the user must confirm the counterpart of the incoming/originating signal by inspecting each call particulars one by one to know the distribution of the call particulars with the specific counterpart.

Moreover, the call particulars items according to the prior art are not in gear with the scheduler function of the existing terminal, which causes an inconvenience in confirming the call particulars and personal schedule at a look.

### SUMMARY OF THE INVENTION

It is, therefore, a primary object of the present invention to provide a wireless communication terminal with a call particulars output function of a scheduler interface and method therefor which is capable of easily learning a distribution of call particulars as the unit of month by displaying incoming/originating call particulars and absent telephone particulars through the use of a scheduler interface in months.

Another object of the present invention is to provide a wireless communication terminal with a call particulars output function of a scheduler interface and method therefor which is capable of doing a schedule management more easily by displaying call particulars with a specific counterpart selected according to a key input signal together with schedule details with the same counterpart.

In accordance with one aspect of the present invention, there is provided a wireless communication terminal with a call particulars output function of a scheduler interface, the wireless communication terminal including: a wireless transceiver for transmitting and receiving a wireless signal to and from external equipments; a storage device for storing a call log including call particulars, and a scheduler interface providing program; an input device for receiving a call particulars output request signal; an output device for outputting information under the control of a controller; and the controller for controlling each of the elements to activate the scheduler interface providing program stored in the storage device in response to the call particulars output request signal, search call particulars for a selected month from the call log, and output the searched information via a scheduler interface.

The storage device further performs a function of storing a registered schedule, the input device further conducts a function of inputting a search-related signal of call particulars with a specific call counterpart, and the controller further performs a function of controlling, in response to the search-related signal of call particulars search with the specific call counterpart from the input device, each of the elements to search call particulars for the selected month from the call log, and output the searched information together with registered schedule associated with the call counterpart via the scheduler interface.

In accordance with another aspect of the present invention, there is provided a call particulars output method of a scheduler interface in a wireless communication terminal, the method including the steps of: a) inputting a call particulars output request signal; b) activating a scheduler interface providing program in response to the call particulars output request signal; c) searching call particulars for a selected month from a call log; and d) outputting call particulars for each date via the scheduler interface.

In accordance with still another aspect of the present invention, there is provided a call particulars output method of a scheduler interface in a wireless communication terminal, the method including the steps of: a) inputting a search-related signal of call particulars with a specific call counterpart; b) searching call particulars with the specific call counterpart issued in a selected month from a call log; and c) outputting call particulars for each date together with a registered schedule associated with the specific call counterpart via the scheduler interface.

The other objectives and advantages of the invention will be understood by the following description and will also be appreciated by the embodiments of the invention more clearly. Further, the objectives and advantages of the invention will readily be seen that they can be realized by the means and its combination specified in the claims.

### BRIEF DESCRIPTION OF THE DRAWINGS

The above and other objects and features of the instant invention will become apparent from the following description of preferred embodiments taken in conjunction with the accompanying drawings, in which:

FIG. 1 is an exemplary configuration diagram showing one embodiment of a wireless communication terminal with a call particulars output function of a scheduler interface in accordance with the present invention;

FIG. 2 is an exemplary flowchart showing one embodiment of a call particulars output method using a scheduler interface in the wireless communication terminal in accordance with the present invention; and

FIGS. 3a and 3b are views of explaining one embodiment of the scheduler interface provided by the wireless communication terminal in accordance with the present invention.

### DETAILED DESCRIPTION OF THE INVENTION

The above-mentioned objectives, features, and advantages will be more apparent by the following detailed description in association with the accompanying drawings; and the technical spirit of the invention will readily be conceived by those skilled in the art to which the invention belongs. Further, in the following description, well-known arts will not be described in detail if they would obscure the gist of the invention in unnecessary detail. Hereinafter, a preferred embodiment of the present invention will be described in detail with reference to the accompanying drawings.

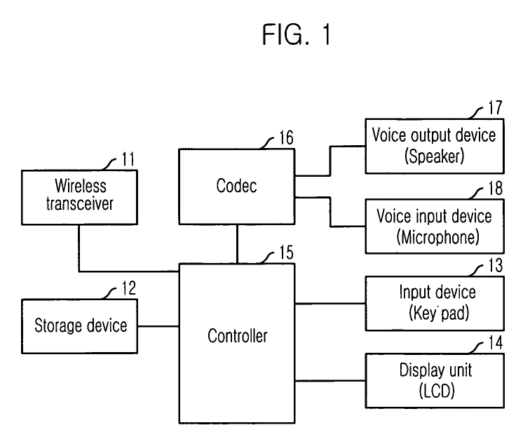

FIG. 1 is an exemplary configuration diagram of a wireless communication terminal with a call particulars output function of a scheduler interface in accordance with the present invention.

As illustrated in FIG. 4, the inventive wireless communication terminal with the call particulars output function of the scheduler interface includes a wireless transceiver 11 for transmitting/receiving a wireless signal to/from external equipments, a storage device 12 for storing a call log including call particulars (incoming/originating occurrence or nonoccurrence, a call connection success or failure, counterpart's phone number, etc.) and a scheduler interface providing program for providing an output interface of the call particulars, a telephone directory, a counterpart's image (e.g., picture) matched corresponding to the counterpart registered in the telephone directory, various icons, etc., an input device 13 for getting a call particulars output request signal and various signals associated with a search of individual call particulars among a plurality of call particulars, etc., a display unit (LCD) 14 for providing a scheduler interface under the control of a controller 15, and the controller 15 for controlling each of the elements to output call particulars of a certain month included in the call log via scheduler interface with the form of calendar by activating the scheduler interface providing program stored in the storage device 12 in response to the call particulars output request signal from the input device (keypad) 13, wherein information on the presence or absence of each call particulars is outputted in a lump via the scheduler interface, and according to an individual call particulars search-related signal from the input device (keypad) 13, detailed items (incoming/originating occurrence or nonoccurrence, call connection success or failure, counterpart's phone number, etc.) of the corresponding individual call particulars detected from the call log and relevant detailed information (e.g., call counterpart's name and picture registered in the telephone directory) are outputted via the scheduler interface. In addition, the inventive wireless communication terminal further includes a codec 16 for converting a signal from the wireless transceiver 11 into a speech under the control of the controller 15 to output it to a speech output device (speaker) 17 and converting a speech from a speech input device (microphone) 18 into a signal to transfer it to the controller 15 and then transmit via the wireless transceiver 11, the speech output device 17 for outputting the speech from the codec 16, and the speech input device (microphone) 18 for inputting the speech and delivering it to the codec 16.

Specifically, the input device (keypad) 13 further performs a function of getting a call particulars search-related signal with a specific call counterpart. And, the controller 15 further conducts, according to the search-related signal of the call particulars with the specific call counterpart from the input device (keypad) 13, a function of outputting a registered schedule (e.g., promise schedule) associated with the counterpart together with the call particulars with the counterpart via the scheduler interface. In other words, when outputting the call particulars with the specific call counterpart, the controller 15 outputs not only the detailed items (incoming/originating occurrence or nonoccurrence, call connection success or failure, counterpart's phone number, etc.) of the call particulars contained in the cal log and relevant detailed information (e.g., the counterpart's name and picture) via the scheduler interface of the invention but also the user's registered schedule (e.g., promise schedule) associated with the counterpart together with the call particulars. Of course, the user's registered schedule (e.g., promise schedule) has been stored in the storage device 12.

In accordance with the present invention, the controller 15 controls the entire operation of the wireless communication terminal and also controls each of the elements to provide the call particulars in a lump as the unit of month via the scheduler interface of the invention. Further, in case of the output of the call particulars with the specific call counterpart, the controller 15 controls to output the user's registered schedule associated with the counterpart together via the scheduler interface.

More specifically, in case of outputting the call particulars as the unit of month in a lump, the controller 15 activates, in response to a call particulars output request signal from the input device (keypad) 13, the scheduler interface providing program stored in the storage device 12, and then outputs information on the presence or absence of call particulars for each date of this month using icons and colors in a lump via the scheduler interface, prior to outputting the detailed call particulars. For instance, if there is any call particulars, it may be available to output the same by setting its letter color differently, or adding icons or quadrangular outline thereto. In addition, the controller 15 may provide the call particulars of today in a schedule part (e.g., the right part of the screen) of the scheduler interface in more detail. Namely, it may be allowable to operate in such a manner that the detailed items (incoming/originating occurrence or nonoccurrence, call connection success or failure, counterpart's phone number, etc.) included in the call particulars of this day, and the relevant detailed information (e.g., counterpart phone number, picture) detected from the storage device 12 using the detailed items are first displayed in the schedule part of the scheduler interface, and then, according to a following individual call particulars search-related signal, various kinds of detailed items for call particulars of a corresponding date and pertinent detailed information are displayed. Accordingly, the user can designate date needing a more detailed confirmation of the call particulars by moving a cursor after confirming the presence or absence of the call particulars for each date via the scheduler interface of the invention, and then confirm the detailed call particulars (i.e., the detailed items of the call particulars and relevant detailed information) for the designated date through the schedule part (e.g., the right part of screen) of the scheduler interface. In other words, the scheduler interface of the invention functions as an interface that includes one part for representing the presence or absence of the call particulars for each date occurred in a certain month in the form of calendar using icons, color, etc., and another part for displaying the detailed items of the call particulars for the certain date selected by the user and relevant detailed information.

Now, a process of outputting individual call particulars using the schedule part (e.g., the right part of screen) of the scheduler interface will be described below. Specifically, the controller 15 outputs, in response to an input of an individual call particulars search-related signal for a certain date, various kinds of detailed items such as incoming/originating occurrence or nonoccurrence, call connection success or failure, counterpart's phone number, incoming/originating time, etc., included in the call log together with relevant detailed information, for example, counterpart's name searched from the telephone directory of the storage device 12 using the counterpart's phone number involved in the call log and counterpart's picture searched from the storage device 12 via the scheduler interface of the invention. The counterpart's picture may be found from the storage device 12 by setting the counterpart's phone number, or the counterpart's name searched from the telephone directory using the counterpart's phone number as the search conditions. In case of more than one call particulars for the relevant date, they may be sorted and outputted depending on the incoming/originating call time of each call particulars.

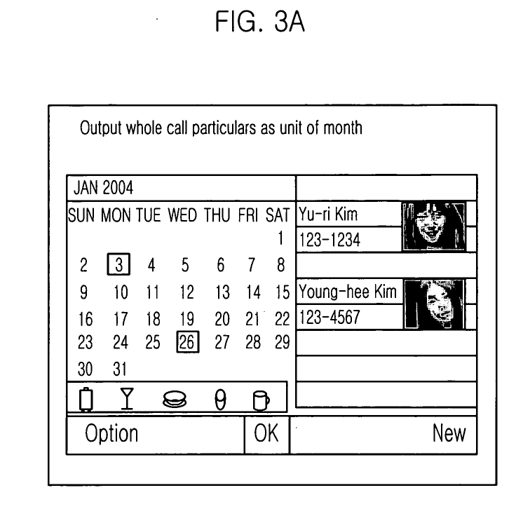

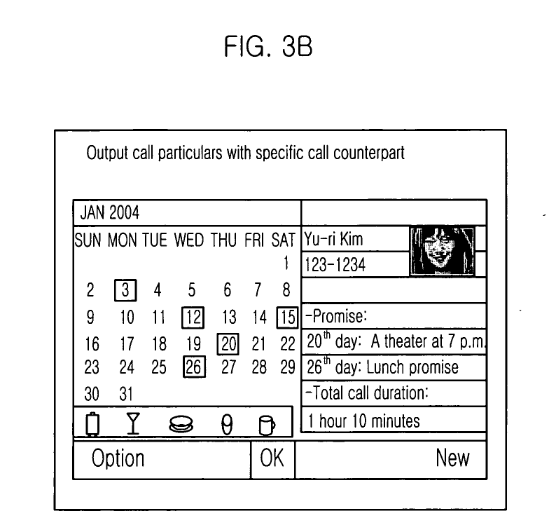

Further, the controller 15 may output not only the call particulars for each date of this month in response to the individual call particulars search-related signal but also the call particulars for a previous month, which are derived by searching them from the call log. A process of outputting the call particulars as the unit of month as mentioned above will be described in detail referring to FIG. 3a later.

On the other hand, as another embodiment of the invention, the controller 15 may output, in response to the call particulars output request signal from the input device (keypad) 13, the presence or absence of call particulars for each date using icons and color, etc. via one part of the scheduler interface of the invention, and at the same time sort and output the call particulars (i.e., the detailed items of the call particulars and relevant detailed information) for each date issued in the corresponding month via another part of the scheduler interface.

Namely, the present invention may be implemented that the detailed items of the call particulars for each date and relevant detailed information are not outputted according to the input of the individual call particulars search-related signal, and instead, the information on the presence or absence of the call particulars for each date and the detailed call particulars are outputted via the scheduler interface, simultaneously with the input of the call particulars output signal request signal. At this time, the user can confirm the call particulars (i.e., the detailed items of the call particulars and relevant detailed information) for each date that has been sorted according to a certain criterion (e.g., the sequence of time) through a scroll function, etc.

In the meantime, in case of outputting the call particulars with the specific call counterpart via the scheduler interface, the controller 15 outputs the user's registered schedule (e.g., promise schedule) associated with the counterpart as well as the call particulars (the detailed items and relevant information) with the counterpart via the scheduler interface of the invention.

To be more specific, in response to the search-related signal of the call particulars with the specific call counterpart provided from the input device (keypad) 13, the controller 15 searches and outputs call particulars with the counterpart issued in a month (e.g., this month) selected by the user from the call log in the storage device 12 via the scheduler interface of the invention. In other words, through the scheduler interface with the form of calendar, using icons, color, etc. provides the presence or absence of the call particulars for each date of this month. Further, in response to the individual call particulars search-related signal, the individual call particulars of the corresponding date, i.e., various kinds of detailed items (incoming/originating occurrence or nonoccurrence, call connection success or failure, counterpart's phone number, incoming/originating time, etc.) and relevant detailed information (e.g., counterpart's name and picture) are outputted in the schedule part (e.g., the right part of the screen) of the scheduler interface.

And also, the controller 15 confirms whether or not there is the user's registered schedule stored in advance in the storage device 12 using the counterpart's phone number (or the counterpart's name). That is, if there exists the schedule registered regarding the counterpart's phone number or the counterpart's name (for example, if the counterpart's name is involved in the subject of the registered schedule), the controller 15 outputs the schedule particulars together with the call particulars associated with the counterpart via the scheduler interface of the invention. For instance, if the promise schedule is registered as the user's schedule, the controller 15 may output time, place, special matters, etc. And, if the registered schedules are more than one, they may be sorted in the sequence of time and then outputted. At this time, the controller 15 may output the call particulars with the counterpart, i.e., various kinds of detailed items and pertinent detailed information in the right upper part of the screen and also the registered schedule associated with the counterpart in the right lower part. Further, it may be available to make the contents of the registered schedule obvious at a look using various kinds of icons. Even though there is explained in the foregoing the process of searching and outputting the call particulars, and then searching and outputting the registered schedule associated with the counterpart, it will be possible to change the operational order each other.

In addition, the controller 15 may compute total call duration with the specific counterpart as the unit of month and then output the result via the scheduler interface. Details of the output of the call particulars and registered schedule with the specific call counterpart as set forth above will be described later with reference to FIG. 3b.

On the other hand, the storage device 12 stores the operational program and system program of the controller, wherein those programs are stored in a general read only memory (ROM) and available to erase where necessary. And, the storage device 12 includes a random access memory (RAM) that temporarily stores data created during various operational programs are executed. Further, the storage device 12 stores the scheduler interface providing program for providing the scheduler interface with the form of calendar in accordance with the invention, and also the telephone directory, various kinds of images (e.g., pictures), registered schedules (e.g., promise schedule), and call particulars.

In the meantime, the input device 13, which includes a multiplicity of numeric keys (letter keys) and menu keys, functional keys for executing various kinds of functions, etc., provides key data to the controller 15 in response to any manipulation from the outside. Further, the input device 13 gets the call particulars output request signal for entering a call particulars output menu, and various kinds of signals associated with the individual call particulars search among a plurality of call particulars displayed on the screen as the result created by entering the call particulars output menu. At this time, the individual call particulars search-related signal is used in searching call particulars in terms of date and may be an input signal using a navigational direction key, and so on. If there are more than one call particulars issued at a certain date selected by the input of the individual call particulars search-related signal, each call particulars may sequentially be displayed in the schedule part (e.g., the right part of the screen) of the scheduler interface, thereby enabling the user to fully confirm each call particulars occurred at the same date using the scroll function, navigational direction key, etc.

In addition, the input device 13 further conducts a function of getting the search-related signal of the call particulars with the specific call counterpart. For this, certain identification information capable of identifying call counterpart needing the call particulars search, for example, name, phone number, and sequence number registered in the telephone directory are got to the input device 13.

The display unit 14 is a display device such as LCD and displays the current status of the wireless communication terminal and progress states of the programs, etc. under the control of the controller 15. Namely, it functions to display the whole state of the wireless communication terminal, inputted contents, and so on. Further, the display unit 14 provides the scheduler interface of the invention by the control of the controller 15, and displays the call particulars and the registered schedules via the scheduler interface.

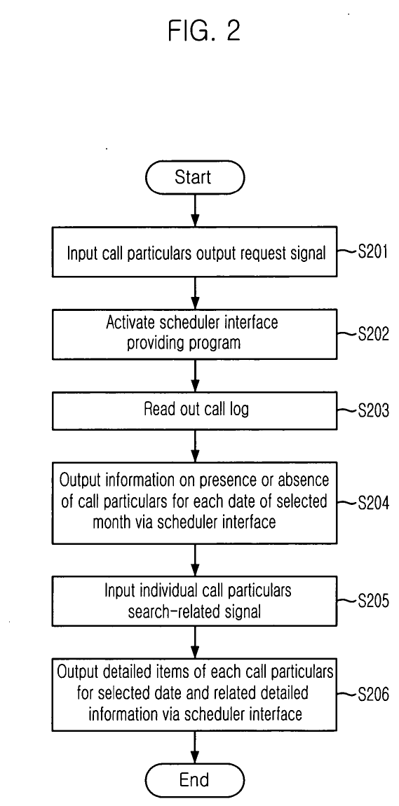

FIG. 2 is an exemplary flowchart showing one embodiment of a call particulars output method using the scheduler interface in the wireless communication terminal in accordance with the present invention.

First of all, at steps S201 and S202, the controller 15 activates the scheduler interface providing program stored in the storage device 12 in response to the call particulars output request signal provided from the input device (keypad) 13. The scheduler interface of the invention displays the call particulars as the unit of month through the screen configuration of the form of calendar. As mentioned above, the scheduler interface includes one part for simply representing the presence or absence of call particulars for each date and another part for providing more detailed call particulars.

Further, the controller 15 reads out, at steps S203 and S204, the call log stored in the storage device 12 and then outputs the presence or absence of call particulars for each date of a certain month (the month selected by the user) using the icons, color, etc. via the scheduler interface. Substantially, after outputting the presence or absence of the call particulars for each date of this month, it would be desirable to output the call particulars for the certain month (the month selected by the user), e.g., a previous month, upon receipt of the input signal from the user using the navigational direction key and so on. At this time, the detailed items of the call particulars and relevant detailed information with respect to this day may be displayed in the schedule part (e.g., the right part of the screen) of the scheduler interface. The presence or absence of the call particulars for each date may be represented by various methods such as setting a certain icon or color of the letter differently.

Further, at steps S205 and S206, the controller 15 outputs the detailed item of each call particulars and relevant detailed information for a date selected according to the individual call particulars search-related signal from the input device (keypad) 13 via the scheduler interface. That is, the user can confirm the presence or absence of the call particulars for each date of the certain month through the scheduler interface of the invention and then input the individual call particulars search-related signal for the search of the call particulars for each date, thereby confirming the call particulars issued at a date the user wants the confirmation. The call particulars occurred at the desired date may be more than one.

Now, details of the process of searching and outputting the individual call particulars will be given below. When the controller 15 outputs the presence or absence of the call particulars for each date of the certain month via the scheduler interface and then inputs the individual call particulars search-related signal from the input device 13, it sequentially outputs the call particulars for the certain date selected by the user, i.e., the detailed items of each call particulars and relevant detailed information in the schedule part (e.g., the right part of the screen) of the scheduler interface. For instance, the detailed items of the call particulars may be the incoming/originating occurrence or nonoccurrence, call connection success or failure, counterpart's phone number, incoming/originating time, etc. Of course, only the counterpart's phone number may be outputted more simply. Further, the relevant detailed information may, for example, be the counterpart's name, counterpart's picture (the picture matching with the counterpart's name or phone number), etc., which are searched from the telephone directory using the counterpart's phone number. In case the call particulars for the certain date are plural, they may be sorted on the basis of the incoming/originating time and then outputted in sequence (in this case, the user may confirm each call particulars occurred at the same date using the scroll function, navigational direction key, etc.).

After that, when the controller 15 receives the call particulars output request signal for a new month through the navigational direction key and so on, it can again search the call particulars occurred in the certain month from the call log and then output it in the same manner as mentioned above via the scheduler interface.

As another embodiment of the invention, an operation of searching and outputting the call particulars with the specific counterpart as the unit of month will now be explained. In this case, the user's registered schedule (e.g., promise schedule) associated with the counterpart is outputted together through the scheduler interface according to the invention.

Specifically, the controller 15 searches, in response to the search-related signal of the call particulars with the specific call counterpart provided from the input device (keypad) 13, the call particulars with the relevant counterpart for a certain month (the month selected from the user) from the call log and then outputs the presence or absence of call particulars for each date using the icon, color, etc. via the scheduler interface of the invention.

In the meantime, the scheduler interface providing program for providing the scheduler interface has already been activated or may be activated in response to the input of the search-related signal of the call particulars with the specific call counterpart. Namely, in order to output the call particulars of the specific call counterpart, it is available to firstly output the whole call particulars for a certain month (e.g., this month) by entering the call particulars output menu according to the call particulars output request signal (the scheduler interface providing program is activated), and then output the call particulars with the relevant counterpart by entering the lower option menu according to the input of the search-related signal of the call particulars with the specific counterpart. Alternatively, the screen for selecting one of a plurality of detailed menus may firstly be displayed according to the input of the call particulars output request signal, and then the call particulars with the specific counterpart may be outputted, according to the input of the call particulars search-related signal with the counterpart (the scheduler interface providing program is activated). As such, there may be a variety of schemes of going into the call particulars output menu with the specific call counterpart. In the second scheme, for example, as the detailed menus that can be selected by the input of the call particulars output request signal, there are the whole call particulars output menu, and the call particulars output menu with the specific call counterpart, etc.

Further, the controller 15 outputs the presence or absence of the call particulars with the relevant counterpart with respect to each date using the icons, color, etc. via the scheduler interface, clearly, the presence or absence of the call particulars with respect to each date in one part (e.g., the left part of the screen) that constitutes the screen in the form of calendar. In the foregoing, there may be outputted in another part (the right part of the screen) of the scheduler interface the detailed items of call particulars occurred this day, for instance, the incoming/originating presence or absence, call connection success or failure, detailed information associated with the counterpart's phone number, e.g., the counterpart's name and picture.

After that, the controller 15 outputs, in response to the individual call particulars search-related signal provided from the input device (keypad) 13, the call particulars for a date selected from the user, i.e., the detailed items of the call particulars and relevant detailed information in another part of the scheduler interface. Further, using the counterpart's phone number, the registered schedule (e.g., promise schedule) of the user associated with the counterpart is searched and then the searched registered schedule if any is outputted together. In the foregoing, the individual call particulars search-related signal may be an input signal using the navigational direction key, etc.

FIGS. 3a and 3b are views of explaining one embodiment of the scheduler interface provided by the wireless communication terminal in accordance with the present invention.

As shown in FIGS. 3a and 3b, the inventive scheduler interface includes one part for representing the presence or absence of the call particulars for each date through the screen of the form of calendar as the unit of month, and another part for providing each call particulars issued at a certain date in more detail. If one part is the left one of the whole screen, another part may be the right one thereof, while if one part is the upper one of the whole screen, another part may be the lower one thereof.

Now, a process of outputting the whole call particulars as the unit of month will be described below referring to FIG. 3a. Through one part (i.e., the left part) of the calendar form, the presence or absence of the call particulars for each date was outputted via the quadrangular outline. That is, for a date (e.g., the 3^{rd} day) with the call particulars, the quadrangular outline is outputted together, thereby showing the presence of more than one call particulars for that date. And also, for representing the presence or absence of the call particulars for each date, there are various methods. For example, a certain icon (e.g., icon with the shape of telephone receiver) may be outputted with the date, or the letter representing the date may be provided with a different color. Further, the quadrangular outline may be used for representing this day (here, the 26^{th} day). And, the user may choose a certain date desiring the confirmation of the call particulars by moving a cursor on one side of the calendar form using the navigational direction key, etc.

On the other hand, the detailed items and relevant detailed information of each call particulars occurred at a certain date (here, the 3^{rd} day) selected by the user are provided through another part (i.e., the right part) of the scheduler interface. The detailed items of each call particulars may contain incoming/originating occurrence or nonoccurrence, call connection success or failure (absent telephone or general telephone), incoming/originating time, etc. The relevant detailed information may include the call counterpart's name and picture, etc., which is searched from the telephone directory. Further, it may be implemented that the user selectively can designate the detailed items and relevant information provided via another part of the scheduler interface. That is, as illustrated in FIG. 3a, it may be available to provide the counterpart's phone number as the detailed item of the call particulars and the counterpart's name and picture as the relevant detailed information.

Referring now to FIG. 3b, a process of providing the call particulars with the specific counterpart as the unit of month will be given below. As illustrated therein, the presence or absence of the call particulars with the specific counterpart for each date is outputted through the quadrangular outline. That is, with respect to the 3^{rd} day, the 12^{th} day, the 15^{th} day with the call particulars with the specific counterpart, the quadrangular outline is provided together, which is distinguishable from the other dates. Further, the detailed items (here, phone number) of the call particulars with the specific counterpart and the relevant detailed information (here, name and picture) are provided through another part (i.e., the right part) of the scheduler interface.

And also, the registered schedule associated with the counterpart is outputted together through another part. For instance, the promise at the A theater at 7 p.m. on 20^{th} day, and the lunch promise on 26^{th} day may be outputted. According to the contents of the registered schedule, the relevant icon may be given on the screen as the registered schedule or additionally. For example, in case of the lunch promise, it may be implemented that the icon with the shape of hamburger is provided to show the lunch promise in a lump.

It may also be designed that the total call duration (e.g., total call duration as the unit of month), total originating duration, total incoming duration, etc. with the counterpart are computed additionally and outputted via said another part.

Even though the call particulars are provided through the scheduler interface of the invention in the foregoing description as one example wherein the present or absence of call particulars is given via one part while the detailed items and relevant detailed information is provided via another part, it will be apparent to change a part of the detailed items, for example, to provide the call connection success or failure via one part.

As set forth above, the present invention can elevate the convenience of user upon confirmation of call particulars by enabling the confirmation of the call particulars at a glance via the scheduler interface.

Namely, the invention can allow the issuance of the call particulars to be confirmed more easily via the screen configuration of the calendar form, thereby readily learning the frequency of the call as the unit of month and wireless communication fee incurred in terms of month.

Moreover, the invention can enable the user to easily grasp the call frequency and schedule with the specific person by providing the call particulars and schedule details with the specific counterpart together via the scheduler interface.

The method of the present invention as mentioned above may be implemented by a software program and stored in storage medium such as CD-ROM, RAM, ROM, floppy disk, hard disk, optical magnetic disk, etc., which are readable by a computer. Since the process may readily be conceived by those skilled in the art, details thereof are omitted here for the sake of brevity.

The present application contains subject matter related to Korean patent application No. 2005-0012670, filed with the Korean Intellectual Property Office on Feb. 16, 2005, the entire contents of which are incorporated herein by reference.

While the present invention has been described with respect to the particular embodiments, it will be apparent to those skilled in the art that various changes and modifications may be made without departing from the spirit and scope of the invention as defined in the following claims.

What is claimed is:

1. A wireless communication terminal with a call particulars output function of a scheduler interface, the wireless communication terminal comprising:
a wireless transceiver for transmitting and receiving a wireless signal to and from external equipments;
a storage device for storing a call log including call particulars, and a scheduler interface providing program;
an input device for receiving a call particulars output request signal;
an output device for outputting information under the control of a controller; and
the controller for controlling each of the elements to activate the scheduler interface providing program stored in the storage device in response to the call particulars output request signal, search call particulars for a selected month from the call log, and output the searched information via a scheduler interface.

2. The wireless communication terminal as recited in claim 1, wherein the controller controls, in response to the call particulars output request signal, each of the elements to activate the scheduler interface providing program stored in the storage device, search call particulars for a selected month from the call log, and output information on a presence or absence of call particulars for each date via the scheduler interface, wherein in response to an individual call particulars search-related signal from the input device, call particulars issued at a selected date are outputted via the scheduler interface.

3. The wireless communication terminal as recited in claim 1, wherein the controller controls, in response to the call particulars output request signal from the input device, each of the elements to activate the scheduler interface providing program stored in the storage device, search call particulars for a selected month from the call log, and output information on a presence or absence of call particulars for each date issued in the selected month via the scheduler interface, wherein the call particulars for said each date are sorted and outputted via the scheduler interface.

4. The wireless communication terminal as recited in claim 3, wherein the controller provides the information on the presence or absence of call particulars for each date of the selected month in the form of calendar by combining one or more of icons, color, and outline.

5. The wireless communication terminal as recited in claim 3, wherein the controller outputs the call particulars for each date together with detailed items having one or more of information related to incoming/outgoing presence or absence, call connection success or failure, and counterpart's phone number, and relevant detailed information having one or more of each call counterpart's name and picture, via the scheduler interface.

6. The wireless communication terminal as recited in claim 3, wherein the storage device further performs a function of storing a registered schedule,
the input device further conducts a function of inputting a search-related signal of call particulars with a specific call counterpart, and
the controller further performs a function of controlling, in response to the search-related signal of call particulars search with the specific call counterpart from the input device, each of the elements to search call particulars for the selected month from the call log, and output the searched information together with registered schedule associated with the call counterpart via the scheduler interface.

7. The wireless communication terminal as recited in claim 6, wherein the controller further performs a function of calculating a call duration (total call duration, incoming/originating call duration) with the call counterpart and outputting the calculated call duration via the scheduler interface.

8. A call particulars output method of a scheduler interface in a wireless communication terminal, the method comprising the steps of:
a) inputting a call particulars output request signal;
b) activating a scheduler interface providing program in response to the call particulars output request signal;
c) searching call particulars for a selected month from a call log; and
d) outputting call particulars for each date via the scheduler interface.

9. The method as recited in claim 8, wherein the step d) includes the steps of:
d1) outputting information on a presence or absence of the call particulars for each date via the scheduler interface; and
d2) outputting, in response to an individual call particulars search-related signal, call particulars issued at a selected date via the scheduler interface.

10. The method as recited in claim 8, wherein the step d) includes the steps of:
d3) outputting information on a presence or absence of the call particulars for each date via the scheduler interface; and
d4) sorting and outputting call particulars for each date occurred in the selected month via the scheduler interface.

11. The method as recited in claim 9, wherein, in the step d1), the information on the presence or absence of the call particulars for each date is provided through a combination of one or more of icons, color, and outline.

12. The method as recited in claim 9, wherein, in the step d2), detailed items having one or more of incoming/outgoing presence or absence, call connection success or failure, and counterpart's phone number with respect to each call particulars, and relevant detailed information having one or more of call counterpart's name and picture are outputted via the scheduler interface.

13. The method as recited in claim 10, wherein, in the step d3), the information on the presence or absence of the call particulars for each date is provided through a combination of one or more of icons, color, and outline.

14. The method as recited in claim 10, wherein, in the step d4), detailed items having one or more of incoming/outgoing presence or absence, call connection success or failure, and counterpart's phone number with respect to each call particulars, and relevant detailed information having one or more of call counterpart's name and picture are outputted via the scheduler interface.

15. A call particulars output method of a scheduler interface in a wireless communication terminal, the method comprising the steps of:
a) inputting a search-related signal of call particulars with a specific call counterpart;
b) searching call particulars with the specific call counterpart issued in a selected month from a call log; and
c) outputting call particulars for each date together with a registered schedule associated with the specific call counterpart via the scheduler interface.

16. The method as recited in claim 15, wherein the step c) includes the steps of:
c1) outputting information on a presence or absence of call particulars for each date via the scheduler interface; and
c2) outputting, in response to an input of an individual call particulars search-related signal, call particulars issued at a selected date via the scheduler interface together with a registered schedule associated with the specific call counterpart via the scheduler interface.

17. The method as recited in claim 15, wherein the step c) includes the steps of:
c3) outputting information on a presence or absence of call particulars for each date via the scheduler interface; and
c4) sorting and outputting call particulars for each date issued in the selected month together with a registered schedule associated with the specific call counterpart via the scheduler interface.

18. The method as recited in claim 16, wherein, in the step c1), the information on the presence or absence of call particulars for each date is provided by combining one or more of icons, color, and outline.

19. The method as recited in claim 16, wherein, in the step c2), the call particulars for each date, via the scheduler interface, together with detailed items having one or more of incoming/outgoing presence or absence, call connection success or failure, and counterpart's phone number for each call particulars, and relevant detailed information having one or more of call counterpart's name and picture are outputted via the scheduler interface.

20. The method as recited in claim 17, wherein, in the step c3), the information on the presence or absence of call particulars for each date is provided by combining one or more of icons, color, and outline.

21. The method as recited in claim 17, wherein, in the step c4), the call particulars for each date, via the scheduler interface, together with detailed items having one or more of incoming/outgoing presence or absence, call connection success or failure, and counterpart's phone number for each call particulars, and relevant detailed information having one or more of call counterpart's name and picture are outputted via the scheduler interface.

22. The method as recited in claim 17, further comprising the step of computing call duration (total call duration, incoming/outgoing call duration) with the call counterpart and outputting the calculated call duration via the scheduler interface.
